(19) United States
(12) Patent Application Publication
(10) Pub. No.: US 2003/0154067 A1
(43) Pub. Date: Aug. 14, 2003

(54) System and method of foreign language training by making sentences within limited time

(76) Inventors: Say-Ling Wen, Taipei (TW); Zechary Chang, Taipei (TW); Pinky Ma, Beijing (CN)

Correspondence Address: BIRCH STEWART KOLASCH & BIRCH, PO BOX 747, FALLS CHURCH, VA, 22040-0747, US

(21) Appl. No.: 10/067,854

(22) Filed: Feb. 8, 2002

(51) Int. Cl. G06F 17/28

(52) U.S. Cl. 704/7

(57) ABSTRACT

A system and method of foreign language training by making questions and sentences within a limited time are disclosed. Through the disclosed method, the learner at the user end can perform real-time foreign language sentence-making training. The disclosed system includes at least: a central message control module, a sentence-making setting control mode, a sentence-making input determination module, and a sentence pattern database. The disclosed method includes at least the steps of: using a sentence-making setting control module to complete practice settings through, using a sentence-making problem generating module to generate output practice sentences, using a sentence-making input determination to carry out a sentence-making practice process, and the learner completing the sentence-making practice process.

### BACKGROUND OF THE INVENTION

1. Field of Invention

The invention relates to a computer-aided language training system. In particular, the invention relates to a system and a method for performing real-time training of foreign language sentence-making ability, which has the special characters of instantaneously making questions and sentences within a limited time.

2. Related Art

The ultimate goal of learning any language is to master the language so that the learner has no difficulty in listening, speaking, reading and writing. To completely master a language, the learner has to notice the important points in the language. One of the things is the “sentence” because sentences are basic units in a language. Only after thoroughly understand the structures, compositions, word orders, and tense changes of sentence can one create the sentences he or she wants to use at any time; and only after mastering sentence uses can one effectively increase his or her abilities in listening, speaking, reading, and writing sentences in the language.

Therefore, it is necessary for learners to first acquire the abilities in creating sentences and using sentences. Accordingly, one should first starts from the compositions, word orders, and speaking intonation and speed of a sentence. However, as we have learned from the conventional computer-aided learning methods, learners in the usual learning procedure often do not receive sufficient stimulation to continuously correct the learning attitude and to reinforce the learning motivation. Thus, the learning effects are greatly reduced in such boring conditions. Moreover, most of learning and teaching theories neglect the importance of repeated practices on sentence compositions, ordering, and speaking intonation and speed. Consequently, learners cannot effectively familiarize themselves with sentences to enhance their language abilities during the learning process.

The invention tries to find an optimal and effective solution from the drawbacks in conventional computer-aided language training methods. Although there is no effective and well-defined learning theory or training method proposed by either educators or computer-aided teaching experts for people to follow, the invention would like to provide a simple and convenient computer-aided language training system to utilize the mature computer techniques to conquer the above-mentioned problems. It is the hope of the invention to use a more efficient method to encourage learner's interest and to increase the learner's familiarity with sentences.

### SUMMARY OF THE INVENTION

In view of the foregoing, the invention discloses a limited time questioning and sentence-making foreign language training system and method. An objective of the invention is to use compute techniques to help users learning to make sentences in a language. Through a computer-aided language learning system with instantaneous questioning and limited time sentence making, a learner can learn to make sentences within an extremely short time period. The learner will have no problem in the instantaneous choices selection, combination and tense changes of sentences. At the same time, the disclosed system and method can judge whether a sentence made by the learner for a particular expression is correct. The invention also gradually increases the learner's familiarity and fluency with a language by speeding up the interactions in an unnoticeable way. Through a continuous learning and training process, the learner can master a language in listening, speaking, reading and writing sentences and can easily have conversations with native speakers.

To achieve the above objective, the disclosed system provides a learner with a simple and convenient UI (User Interface) for the learner to participate in learning activities provided by the system. The learner only needs to complete problems following provided hints within a limited time. Through the repeated correction and training process, the learner gains the ability in making sentences. The system includes at least: a central message control module, a sentence-making setting control mode, a sentence-making input determination module, and a sentence pattern database.

The disclosed method includes at least the steps of: using a sentence-making setting control module to complete practice settings through, using a sentence-making problem generating module to generate output practice sentences, using a sentence-making input determination to carry out a sentence-making practice process, and the learner completing the sentence-making practice process.

### BRIEF DESCRIPTION OF THE DRAWINGS

The invention will become more fully understood from the detailed description given hereinbelow illustration only, and thus are not limitative of the present invention, and wherein:

FIG. 1 is a system structure of the disclosed foreign language training system and method for making questions and sentences within a limited time;

FIG. 2-a shows the whole procedure of the disclosed system and method;

FIG. 2-b shows the procedure for making a sentence in the disclosed system and method;

FIG. 2-c shows the procedure for judging a sentence input in the disclosed system and method; and

FIG. 3 is a schematic view of an explicit embodiment of the disclosed system and method.

### DETAILED DESCRIPTION OF THE INVENTION

The disclosed foreign language training system and method are designed to provide a convenient and simple computer-aided language learning means to solve problems of learning to make sentences in a conventional way. The learner at the user end only needs to use a UI (User Interface) to enter the system to participate in the learning activities provided by the system. The learner has to follow the hints given by the system in voice and text to answer questions and problems within a limited time. Through a continuous, repeated correction and training process, the learner can increase his or her ability in making sentences in a foreign language.

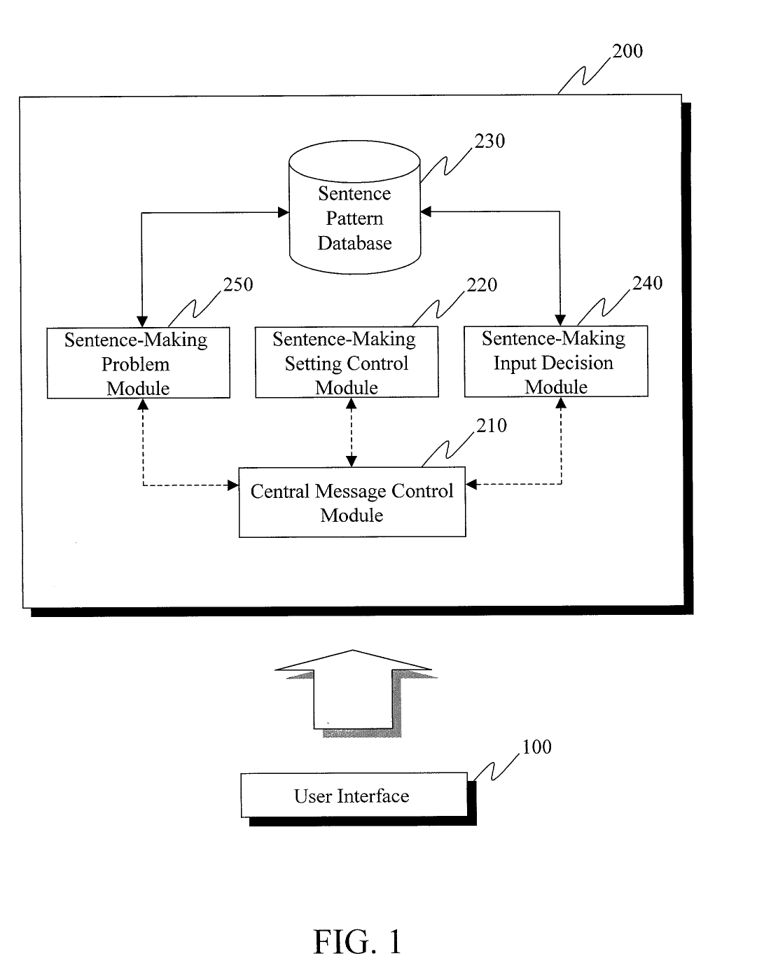

A preferred embodiment is used to explain the feasibility of the invention. With reference to FIG. 1, a foreign language training system 200 is used to process all foreign language sentence-making practice activities. When a learner wants to use the system 200, he or she enters the system through a UI 100. The UI 100 uses a basic I/O (Input/Output) device to perform inputs and outputs. Such an I/O device can be a keyboard, a mouse, a digital touch-control panel, and a voice-playing system. The foreign language training system 200 includes (1) a central message control module 210, (2) a sentence-making setting control module 220, (3) a sentence pattern database, and (4) a sentence-making input determination module.

(1) The central message control module 210 is used to control the identity of a user who logs into the system 200 and to record all operation processes the user produces through the UI 100. When a user enters the system 200, a control message is generated to monitor the whole process so that other function modules are called at proper times to perform the corresponding processes. The module 210 is mainly used to record the messages exchanged among different modules and to store data kept by each module and, in particular, the process management and personal message storage.

(2) The sentence-making setting control module 220 is used to provide options of all control settings for the practice process. Such options include: the length of a sentence in problems, the style of sentences in problems, the length of a limited time for answering a problem, and the speed of reading a sentence, etc. When a control message from the central message control module 210 is received, a setting message is generated to start the setting task.

(3) The sentence pattern database 230 is used to store at least one set of sample data for sentence pattern. The sample data include fields for: sentence pattern codes, text contents of a sentence, translation of a sentence in the user's native language, and voice contents before and after a sentence to store data related to the sentences (the contents before and after a sentence refer to the question sentences and answer sentences in a sentence pattern). When a question-making message from a sentence-making problem module 250 or a correction message from the sentence-making input decision module 240 is detected, the sample data contents in the sentence pattern, the sentence-making problem module 250, and the sentence-making input decision module 240 are immediately linked together to make problems and to compare answers for corrections.

(4) The sentence-making input decision module 240 is used to receive contents entered by the user for comparisons and corrections. The comparison is done by comparing the answer from the user with the sentence pattern sample data extracted from the sentence pattern database 230 using the corresponding sentence pattern code. When the control message is received, a correction message is immediately generated.

As mentioned before, the system also includes a sentence-making problem module 250 to provide at least one set of sentences for a sentence pattern in the UI 100. These sentences form a basis for making problems according to the setting contents of the sentence-making control module 220. A random number generator is used to pick a sentence. When the setting message is received, a problem-making message is produced to randomly generate a random number. The random number is used to pick the sample data of the corresponding code in the sentence pattern from the sentence pattern database 230.

The foreign language training system 200 can be implemented over any computer executable hardware platform, which can be a PC (Personal Computer), an NB (Notebook), a PDA (Personal Digital Assistant), etc. Any skilled person in the field can make all sorts of modification to the invention without departing from the spirit and scope of the invention to make the system 200 be implemented on any other electronic device.

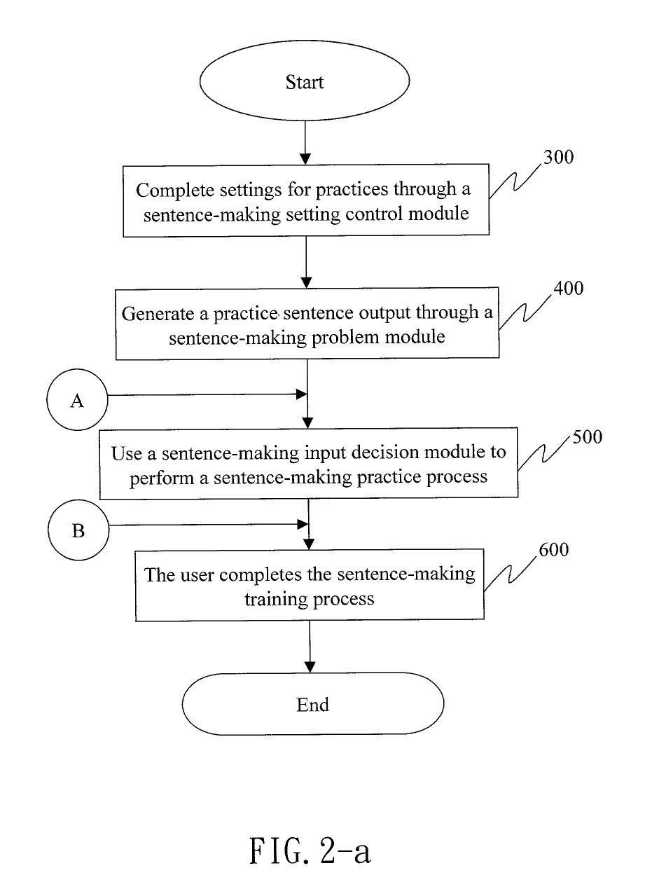

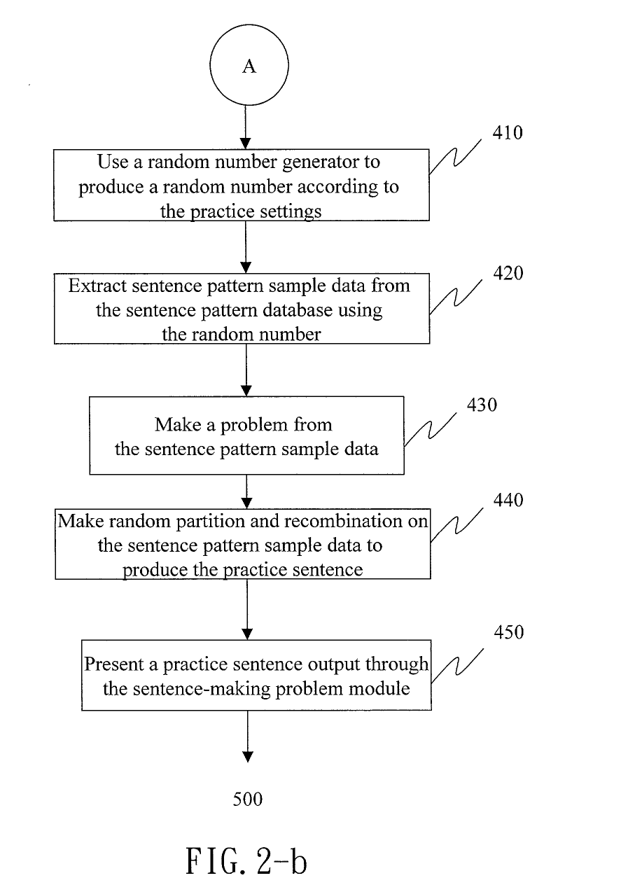

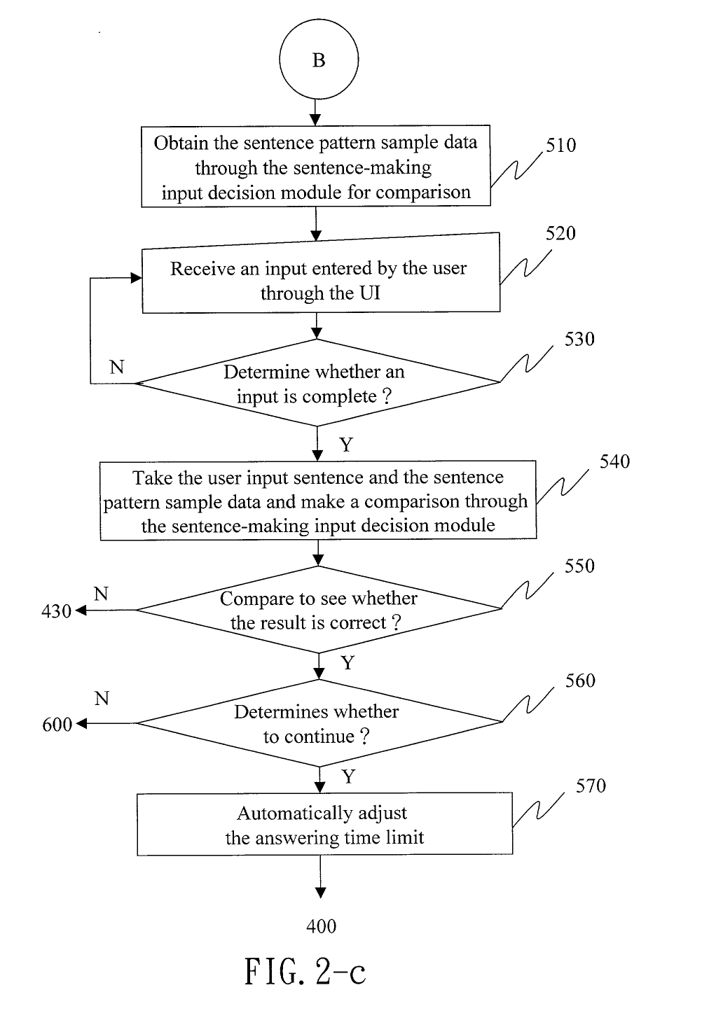

With reference to FIG. 2-a, the detailed procedure of the disclosed method is explained hereinafter. First, a user completes the setting for doing practices through a sentence-making setting control module 220 (step 300). Possible options in the settings include: the length of a sentence in problems, the style of sentences in problems, the length of a limited time for answering a problem, and the speed of reading a sentence, etc. After the basic settings are made, the system 200 uses a sentence-making problem module 250 to generate an output for practice making a sentence (step 400). The detailed procedure is step A listed in FIG. 2-b. Afterwards, the system 200 uses a sentence-making input decision module 240 to decide whether the sentence made and entered by the user is correct (step 500). The detailed procedure is step B given in FIG. 2-c. Finally, the user completes the sentence-making practices through the limited-time foreign language training provided by the system 200.

As shown in FIG. 2-b, the procedure of making problems by the sentence-making problem module 250 is detailed as follows. After the user completes the basic settings of the practice modes, to ensure that the learning activities are not limited by the subjects, the system 200 immediately generates a random number using a random number generator (step 410). Such a random number will be used as the sentence pattern code to extract the corresponding sample data. The random number (i.e. the sentence pattern code) is then used to find the corresponding sentence pattern sample data from the sentence pattern database 230 (step 420). The contents of each extracted sentence pattern sample data include at least the fields for: sentence pattern codes, text contents before and after a sentence, translation of a sentence in the user's native language, and voice contents before and after a sentence to store data related to the sentences (the contents before and after a sentence refer to the question sentences and answer sentences in a sentence pattern). When the sentence-making problem module 250 obtains the sentence pattern sample data, the translation of the sentence, the text contents before and after the sentence, and the voce contents before and after the sentence are shortly presented in any combination in the UI 100 (step 430). The primary objective is to allow the user to have a rough understanding of what the sentence-making practice contents are. The user can first have some ideas to form parts of a sentence in advance to speed up subsequent answers. Afterwards, the sentence-making problem module 250 performs random partition and recombination in the text contents of the sentence pattern sample data, generating a practice sentence (step 440). The sentence-making problem module 250 then output the practice sentence to the UI 100 in texts and voices (step 450) for the user to continue subsequent sentence-making processes.

With reference to FIG. 2-c, the operations of the sentence-making input decision module 240 are detailed as follows. First, the sentence-making input decision module 240 obtains the text contents of the corresponding sentence pattern sample data as the standard for comparison (step 510). It then waits for the answer entered by the user through the UI 100 (step 520). The module 240 keeps detecting whether the user input is completed while waiting (step 530). If there is not input from the user, then the module 240 keeps waiting; if the user has entered an answer sentence and pressed the FINISH key to enter the result, then the sentence-making input decision module 240 immediately starts to compare the user's answer with the sentence pattern text contents (step 540). If the comparison result indicates that the user's answer is different from the solution sentence pattern text contents, the system 200 automatically returns to step 430 to show the problem again until the user gives the correct answer. The user can receive real learning effects through repeated practices (step 550). If the user answers correctly, then the system asks the user whether the user wants to continue participating the training (step 560). Suppose the user is willing to continue the practice, the system 200 automatically adjusts the time limitation allowed for answering questions according to the settings in the sentence-making setting control module 220, gradually increasing the user's familiarity and fluency in making sentences (step 570). If the user is not willing to do the practice, the procedure continues to step 600, ending the sentence-making practices.

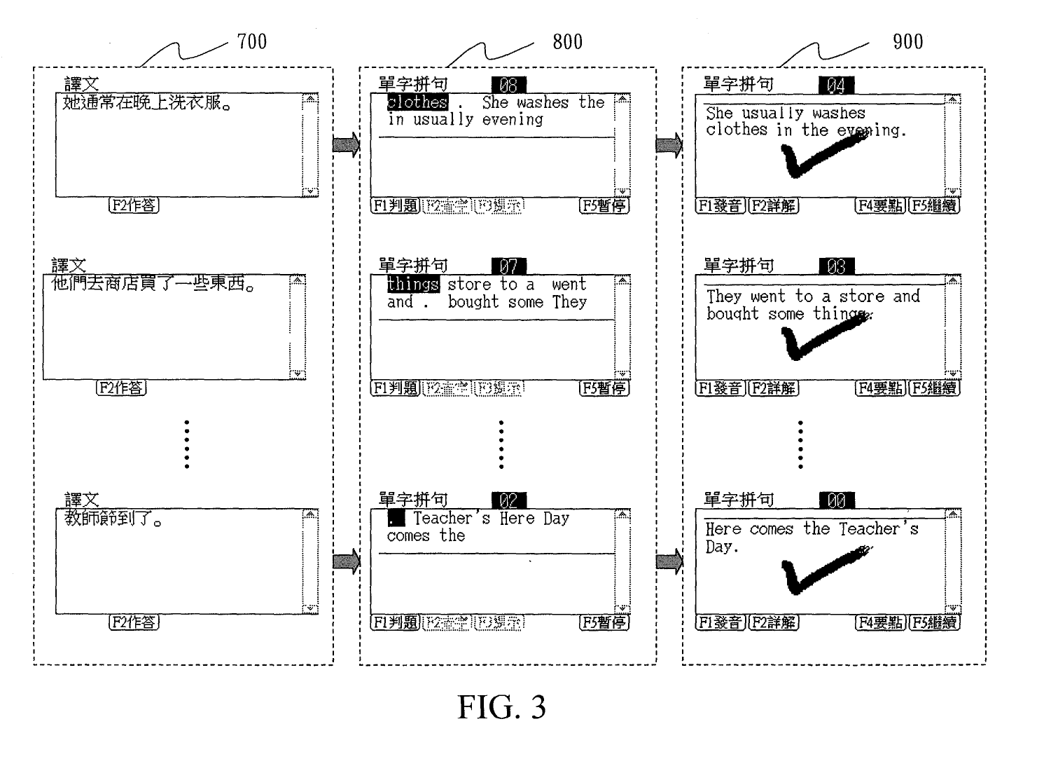

With reference to FIG. 3, when the learner enters the system 200 through the UI 100 and completes the basic settings for training, he or she then enters the screen of sentence-making practices. After the sentence-making problem module 250 selects the sentence pattern sample to make a problem, the translation text contents of the sample are shortly presented in the translation text content screen 700. The voice contents of the translation text are simultaneously played. Afterwards, the partitioned and shuffled sentence pattern text contents are presented in the sentence-making practice screen 800 for the user's reference in making sentences. Finally, the user starts to enter the answer in the user input screen 900.

It should be noted that the system 200 uses the contents set in the sentence-making setting control module 220 as the basis to perform practices. The whole practice is performed under the constraint of a limited time. For example, the sentence-making practice screen 800 in the first part provided by the system lasts for eight time units in the beginning. The user input screen 900 lasts for four time units. (The time unit can be defined by the user.) After the user answers the problems within the given time limit, the system slowly shortens the browsing and answering time limit in an unnoticeable way. In the second part of the drawing, the time limit for the sentence-making practice screen 800 reduces to seven time units and that for the user input screen down to three time units. Such process continues until the minimum time limit set by the user is reached (e.g. the third part in the drawing).

### EFFECTS OF THE INVENTION

The disclosed foreign language training system and method by making questions and sentences within a limited time hope to utilize mature computer techniques to aide the learning activities for improving language skills. The user can have real-time interactions in the learning process through simple operation provided by a UI (User Interface). By making questions and problem in a random way, a wide variety of learning materials can be provided to the learner. The system can also provide immediate corrections to the learner during the learning process. This enables the learner to correct his or her sentence structure at the first time. Furthermore, the invention also includes an important concept in a classic game—tetris. That is, a time limit control factor is imposed in the training process and the time limit is gradually shortened to make level advance. Therefore, the learning activities become more challenging and interesting, thereby encouraging the learner to practice more often.

Through the above factors for improving learning effects, the learner can get more familiar with sentences of a new language within an extremely short time period. The learner will have no problem in the instantaneous choices selection, combination and tense changes of sentences. At the same time, the disclosed system and method can judge whether a sentence made by the learner for a particular expression is correct. The invention also gradually increases the learner's familiarity and fluency with a language by speeding up the interactions in an unnoticeable way. Through a continuous learning and training process, the learner can master a language in listening, speaking, reading and writing sentences and can easily have conversations with native speakers.

What is claimed is:

1. A foreign language training system for making questions and sentences within a limited time operated through an operating interface at a user end to perform real-time foreign language sentence-making practices, which system comprises:
a sentence-making setting control module, which allows control option settings at the user end to perform different practices;
a sentence pattern database, which stores at least one set of sentence pattern sample data that are to be extracted using a sentence pattern code;
a sentence-making input decision module, which takes an input entered at the user end and compares it with the sentence pattern sample data extracted from the sentence pattern database; and
a central message control module, which monitors and controls operations performed at the user end, generates different control messages corresponding to the control operations, and transmits the control messages through the linkage with each of said modules;
wherein after the comparison is finished the central message control module determines whether the same problem is given or a new problem should be made according to the comparison result.

2. The system of claim 1 further comprising a sentence-making problem module, which determines the sentence pattern code through a random number generator and extracts a corresponding sentence pattern sample data from the sentence pattern database.

3. The system of claim 2, wherein the random number generator generates random numbers using a random number series stored in a random number table.

4. The system of claim 1, which is implemented on a computer executable hardware platform.

5. The system of claim 4, wherein the computer executable hardware platform is selected from the group consisting of a PC (Personal Computer), an NB (Notebook computer), a PDA (Personal Digital Assistant).

6. A foreign language training method for making questions and sentences within a limited time to perform real-time foreign language sentence-making practices through an operating interface at a user end, which method comprises the steps of:
using a sentence-making setting control module to complete settings for how to perform practices;
using a sentence-making problem module to generate a practice sentence output;
using a sentence-making input decision module to perform a sentence-making process; and
a user finishing the sentence-making training process.

7. The method of claim 6, wherein the contents of the settings for how to perform practices include the length of a sentence in problems, the style of sentences in problems, the length of a limited time for answering a problem, and the speed of reading a sentence.

8. The method of claim 7, wherein the style of sentences in problems includes at least an original tense and a variation tense.

9. The method of claim 6, wherein the step of using a sentence-making problem module to generate a practice sentence output; further comprises the steps of:
using a random number generator to generate a random number according to the setting for how to perform practices;
extracting a corresponding sentence pattern sample data from the sentence pattern database using the random number;
presenting a problem sentence pattern in the sentence pattern sample data for a short time period;
performing random partition and recombination on the sentence pattern sample data to generate the practice sentence; and
using the sentence-making problem module to make an output presentation of the practice sentence.

10. The method of claim 9, wherein the random number generator generates the random number using a random number series stored in a random number table.

11. The method of claim 9, wherein the sentence pattern sample data include at least fields for sentence pattern codes, text contents before and after a sentence pattern, translation text contents of a sentence pattern in the user's native language, voice contents before and after a sentence pattern.

12. The method of claim 11, wherein both the text contents before and after the sentence pattern and the voice contents before and after the sentence pattern include question sentences and answer sentences.

13. The method of claim 9, wherein the problem sentence pattern to be presented for a short time period is selected from the group consisting of combinations of the text contents before and after a sentence pattern, translation text contents of a sentence pattern in the user's native language, voice contents before and after a sentence pattern.

14. The method of claim 9, wherein the random partition and recombination are performed at each time a new problem is made.

15. The method of claim 9, wherein the output presentation is done by playing voices and texts at the same time.

16. The method of claim 9, wherein the step of using a sentence-making input decision module to perform a sentence-making process further comprises the steps of:
using the sentence-making input decision module to obtain the sentence pattern sample data to comparison;
receiving an input entered by the user through a UI (User Interface);
using the sentence-making input decision module to perform a comparison between the user entered sentence and the sentence pattern sample data; and
automatically adjusting a problem answering limited time.

17. The method of claim 16, wherein the UI performs I/O (Input/Output) actions through an I/O peripheral device.

18. The method of claim 17, wherein the I/O peripheral device is selected from the group consisting of a keyboard, a mouse, a digital touch-control panel, and a voice playing system.

19. The method of claim 16, wherein the adjustment of the problem answering limited time is determined by an initial value and a change amount in each adjustment set by the user.

20. The method of claim 19, wherein the adjustment of the problem answering limited time is gradually decreased.

21. The method of claim 16, wherein the comparison result is used by the system to determine whether the same problem is given again or a new problem is to be made.
